(19) United States
(12) Patent Application Publication
(10) Pub. No.: US 2020/0139786 A1
(43) Pub. Date: May 7, 2020

(54) AIR-CONDITIONING DEVICE

(71) Applicant: Marelli Corporation, Saitama-shi, Saitama (JP)

(72) Inventor: Koujirou NAKAMURA, Saitama-shi, Saitama (JP)

(21) Appl. No.: 16/629,414

(22) PCT Filed: Jun. 4, 2018
(86) PCT No.: PCT/JP2018/021397

§ 371 Date: Jan. 8, 2020

(30) Foreign Application Priority Data
Jul. 24, 2017 (JP) 2017-142877

(51) Int. Cl. B60H 1/00; B60H 1/22; B60H 1/32

(52) U.S. Cl. CPC B60H 1/00642; B60H 1/32; B60H 1/22; B60H 1/00

(57) ABSTRACT

An air-conditioning device includes: a frost formation determination unit configured to determine a frost risk state of an outdoor hot exchanger based on an accumulated time wherein a difference between a temperature detected by an outdoor air temperature detector and a temperature detected by a coolant temperature detector is the same or greater than a frost temperature difference; and an operation control unit configured to control a compressor and a blower so that air led into the cabin reaches a target blowout temperature set based on a required heating performance, and to execute a regular heating operation. In the event of the frost formation determination unit determining the frost risk state, the operation control unit is configured to execute a frost suppression operation wherein the air flow amount by the blower is increased while the target blowout temperature is decreased in comparison with the regular heating operation.

### CROSS-REFERENCE TO RELATED APPLICATIONS

This is a U.S. national phase application of PCT/JP2018/021397, filed on Jun. 4, 2018, which claims priority to Japanese Patent Application No. 2017-142877, filed on Jul. 24, 2017. The entire disclosure of Japanese Patent Application No. 2017-142877, is hereby incorporated herein by reference.

### TECHNICAL FIELD

The present invention relates to an air-conditioning device.

### BACKGROUND ART

Disclosed in Japanese Unexamined Patent Publication No. 2017-035901A is a vehicular air-conditioning device that performs a heat pump heating operation for heating air blown in a vehicle interior using a refrigerant that is compressed using a compression machine. With this vehicular air-conditioning device, by reducing the air volume that passes through a heater core, raising the high pressure and reducing the endothermic energy amount of an outdoor heat exchanger, frost on the outdoor heat exchanger is delayed.

### SUMMARY

However, with the vehicular air-conditioning device of Japanese Unexamined Patent Publication 2017-035901A, to delay frost on the outdoor heat exchanger, the air volume that passes through the heater core is reduced, so there is a risk of a decrease in heating performance.

The purpose of the present invention is to suppress frost on the outdoor heat exchanger without decreasing the heating performance.

According to a mode of the present invention, an air-conditioning device comprises: a compression machine that compresses a refrigerant; a heater that heats air led to a vehicle interior using heat when the refrigerant compressed by the compression machine condenses; an expansion valve that expands the refrigerant condensed by the heater; an outdoor heat exchanger that vaporizes the refrigerant expanded using the expansion valve by heat exchange with outside air; an air blower that blows air led to the vehicle interior so as to pass through the heater; an outside air temperature detector that detects the temperature of outside air before passing through the outdoor heat exchanger; a refrigerant temperature detector that detects the temperature of the refrigerant that passed through the outdoor heat exchanger; a frost determination unit that determines there is a state in which frost can occur on the outdoor heat exchanger, based on the elapsed time of a state in which the difference between the detection temperature of the outside air temperature detector and the detection temperature of the refrigerant temperature detector is the same or greater than the frost temperature difference at which frost can occur on the outdoor heat exchanger; and an operation control unit that controls the compression machine and the air blower so that the air led to the vehicle interior becomes a target blowout temperature set based on the required heating performance, and executes a normal heating operation, wherein the operation control unit, when the frost determination unit has determined that there is a state in which frost can occur, executes a frost suppression operation of, compared to the normal heating operation, decreasing the target blowout temperature and increasing the air flow amount using the air blower.

With the abovementioned mode, the operation control unit executes the frost suppression operation when there is a state in which frost can occur on the outdoor heat exchanger. With the frost suppression operation, the target blowout temperature of the air led to the vehicle interior is decreased, and the air flow amount by the air blower is increased. As a result, the pressure of the refrigerant compressed by the compression machine drops, the pressure of the refrigerant led to the outdoor heat exchanger rises, and the evaporation temperature rises, so the occurrence of frost on the outdoor heat exchanger is suppressed. Meanwhile, the air flow amount by the air blower is increased by the amount that the target blowout temperature is decreased, so the heat amount of the air led to the vehicle interior does not decrease. Therefore, it is possible to suppress frost on the outdoor heat exchange without decreasing the heating performance.

### BRIEF DESCRIPTION OF THE DRAWINGS

FIG. 1 is a circuit diagram of an air-conditioning device of an embodiment of the present invention.

FIG. 2 is a control block diagram of the air-conditioning device.

FIG. 3 is a drawing for explaining the flow of refrigerant during the cooling operation.

FIG. 4 is a drawing for explaining the flow of refrigerant and hot water during the heating operation.

FIG. 5 is a flow chart for explaining the switching control between a normal heating operation and a frost suppression operation.

FIG. 6 is a flow chart for explaining the control of a heat pump heating mode executed based on a target blowout temperature.

FIG. 7 is a drawing for explaining a same-heat-amount line.

FIG. 8 is a Mollier diagram for explaining the normal heating operation and the frost suppression operation.

### DETAILED DESCRIPTION OF EMBODIMENTS

Following, an air-conditioning device 1 of an embodiment of the present invention is explained while referring to the drawings.

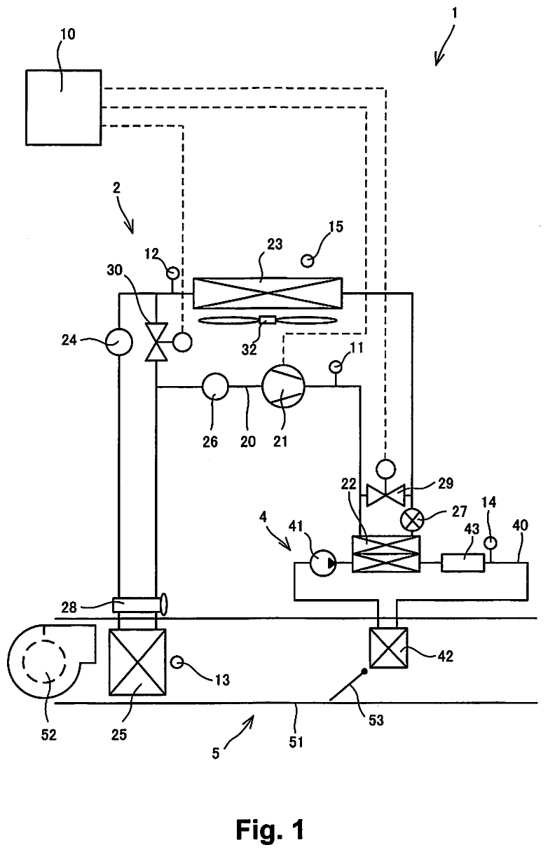

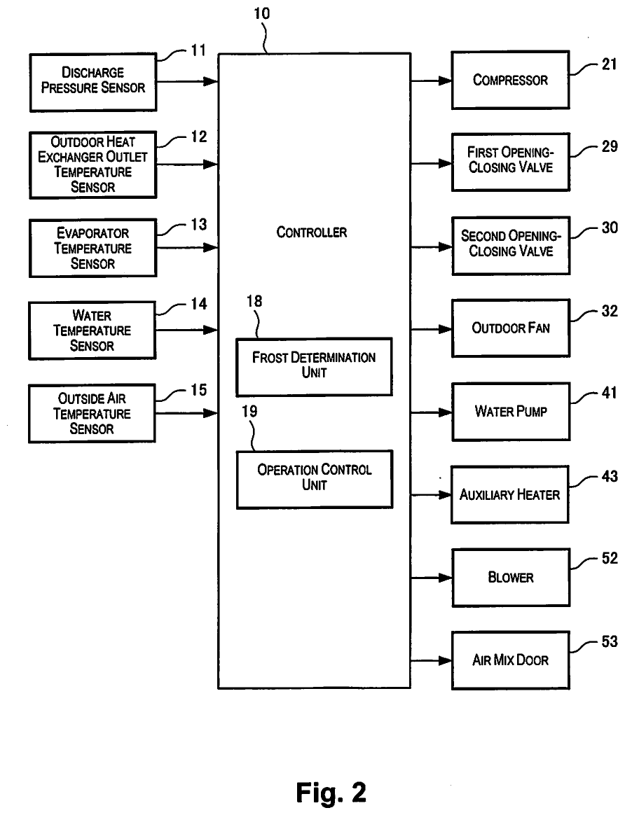

First, the overall configuration of the air-conditioning device 1 is explained while referring to FIG. 1 and FIG. 2.

The air-conditioning device 1 comprises: a refrigeration cycle 2 that circulates refrigerant; a hot water cycle 4 that circulates hot water; an HVAC (Heating Ventilation and Air Conditioning) unit 5 through which air used for air conditioning of a vehicle interior passes; and a controller 10 that controls the operation of valves, etc.

The air-conditioning device 1 is a heat pump system capable of cooling and heating operations. The air-conditioning device 1 is mounted in a vehicle (not illustrated), and performs air conditioning inside the passenger compartment (not illustrated). For example, HFC-134a can be used for the refrigerant, and antifreeze solution can be used for the hot water.

The refrigeration cycle 2 comprises: a compressor 21 as a compression machine; a water-cooled condenser 22 as a hot water-refrigerant heat exchanger; an outdoor heat exchanger 23; a liquid tank 24; an evaporator 25 as a vaporizer; an accumulator 26; and a refrigerant flow path 20 that connects these so that the refrigerant is able to circulate.

The compressor 21 draws in and compresses gaseous refrigerant. By doing this, the gaseous refrigerant becomes high temperature and high pressure.

During the heating operation, the water-cooled condenser 22 functions as a condenser for condensing refrigerant after passing through the compressor 21. The water-cooled condenser 22 performs a heat exchange between the refrigerant that became high temperature and high pressure by the compressor 21 and the hot water that circulates in the hot water cycle 4, and transmits the heat of the refrigerant to the hot water. The water-cooled condenser 22 heats air used for air conditioning led to the vehicle interior via the hot water circulating in the hot water cycle 4. Here, the water-cooled condenser 22 and the hot water cycle 4 are equivalent to a heater for heating air led to the vehicle interior.

Instead of this, it is also possible to have the refrigerant compressed by the compressor 21 directly led to the indoor heat exchanger without providing the hot water cycle 4. In this case, the indoor heat exchanger is equivalent to the heater.

The outdoor heat exchanger 23 is placed inside an engine room (motor room in an electric automobile) of a vehicle, for example, and performs heat exchange between the refrigerant and outside air. The outdoor heat exchanger 23 functions as a condenser during the cooling operation, and functions as a vaporizer during the heating operation. Outside air is led to the outdoor heat exchanger 23 by running the vehicle or rotating an outdoor fan 32.

During the cooling operation, the liquid tank 24 temporarily holds the refrigerant condensed by passing through the outdoor heat exchanger 23, and does gas and liquid separation of the refrigerant into gaseous (gas phase) refrigerant and liquid (liquid phase) refrigerant. From the liquid tank 24, only the separated liquid refrigerant flows to a second expansion valve 28.

The evaporator 25 is placed inside the HVAC unit 5. During the cooling operation, the evaporator 25 vaporizes the refrigerant expanded by the second expansion valve 28 described later, and cools the air used for air conditioning. The refrigerant vaporized by the evaporator 25 flows through the second expansion valve 28 to the accumulator 26.

The accumulator 26 temporarily stores refrigerant flowing in the refrigerant flow path 20, and does gas-liquid separation to gaseous refrigerant and liquid refrigerant. From the accumulator 26, only the separated gaseous refrigerant flows to the compressor 21.

Provided in the refrigerant flow path 20 are the first expansion valve 27 and the second expansion valve 28 that reduce pressure and expand the refrigerant. Also, placed in the refrigerant flow path 20 are a first opening-closing valve 29 and a second opening-closing valve 30 that switch the flow of the refrigerant by opening and closing.

The first expansion valve 27 is place between the water-cooled condenser 22 and the outdoor heat exchanger 23, and reduces pressure and expands the refrigerant condensed by the water-cooled condenser 22. For the first expansion valve 27, for example, a fixed throttle or a variable throttle is used. For the fixed throttle, for example, it is possible to use an orifice or a capillary tube. For the fixed throttle, a throttle amount is set in advance so as to correspond to specific operating conditions that are frequently used. Also, for the variable throttle, for example, it is possible to use an electromagnetic valve that can adjust the opening level either in stepwise or stepless fashion.

The second expansion valve 28 is placed between the liquid tank 24 and the evaporator 25, and reduces pressure and expands the liquid refrigerant led from the liquid tank 24. For the second expansion valve 28, a temperature type expansion valve for which the opening is adjusted according to the temperature of the refrigerant that passed through the evaporator 25 can be used.

The first opening-closing valve 29 is opened during the cooling operation, and closed during the heating operation. When the first opening-closing valve 29 is opened, the refrigerant that was compressed by the compressor 21 bypasses the water-cooled condenser 22 and the first expansion valve 27, and flows directly into the outdoor heat exchanger 23. Meanwhile, when the first opening-closing valve 29 is closed, the refrigerant that was compressed by the compressor 21 passes through the water-cooled condenser 22 and the first expansion valve 27 and flows into the outdoor heat exchanger 23.

The second opening-closing valve 30 is opened during the heating operation and closed during the cooling operation. When the second opening-closing valve 30 is opened, the refrigerant that was vaporized by the outdoor heat exchanger 23 bypasses the liquid tank 24, the second expansion valve 28, and the evaporator 25, and flows directly into the accumulator 26. Meanwhile, when the second opening-closing valve 30 is closed, the refrigerant that was vaporized by the outdoor heat exchanger 23 passes through the liquid tank 24, the second expansion valve 28, and the evaporator 25, and flows into the accumulator 26.

The hot water cycle 4 comprises: a water pump 41 as the pump; a heater core 42 as the heater; a hot water heater 43 as an auxiliary heater; the water-cooled condenser 22; and a hot water flow path 40 that connects these so that hot water can be circulated.

The water pump 41 circulates hot water inside the hot water flow path 40.

The heater core 42 is placed inside the HVAC unit 5, and during the heating operation, heats the air used for air conditioning by doing a heat exchange of the air that passes through the heater core 42 and hot water.

The hot water heater 43 has a heater (not illustrated) in the interior, and heats hot water using external power. For the heater, for example, it is possible to use a sheathed heater or a PTC (Positive Temperature Coefficient) heater. Instead of the hot water heater 43, for example, it is also possible to heat hot water by doing heat exchange with the cooling water of the vehicle engine (not illustrated).

The HVAC unit 5 cools or heats air used for air conditioning. The HVAC unit 5 comprises: a blower 52 as an air blower; an air mix door 53; and a case 51 that encloses these so that air used for air conditioning can pass through. The heater core 42 and the evaporator 25 are placed inside the HVAC unit 5. The air blown from the blower 52 exchanges heat with the refrigerant flowing inside the heater core 42 and the evaporator 25.

The blower 52 is an air blower that blows the air led to the vehicle interior and used for air conditioning into the inside of the HVAC unit 5.

The air mix door 53 regulates the amount of air that passes through the heater core 42 placed inside the HVAC unit 5. The air mix door 53 is installed at the blower 52 side of the heater core 42. The air mix door 53 opens the heater core 42 side during the heating operation, and closes the heater core 42 side during the cooling operation. The heat exchange amount between the air and the hot water inside the heater core 42 is adjusted according to the opening degree of the air mix door 53.

Installed in the air-conditioning device 1 are: a discharge pressure sensor 11 as a discharge pressure detector; an outdoor heat exchanger outlet temperature sensor 12 as a refrigerant temperature detector; an evaporator temperature sensor 13; a water temperature sensor 14; and an outside air temperature sensor 15 as an outside air temperature detector.

The discharge pressure sensor 11 is installed in the refrigerant flow path 20 of the discharge side of the compressor 21, and detects the discharge pressure of the gaseous refrigerant compressed by the compressor 21.

The outdoor heat exchanger outlet temperature sensor 12 is provided at the outlet of the outdoor heat exchanger 23 and detects the temperature of the refrigerant inside the refrigerant flow path 20. The outdoor heat exchanger outlet temperature sensor 12 detects the temperature of the refrigerant that passes through the outdoor heat exchanger 23.

The evaporator temperature sensor 13 is installed at the downstream side of the air flow of the evaporator 25 in the HVAC unit 5, and detects the temperature of the air that passes through the evaporator 25. It is also possible for the evaporator temperature sensor 13 to be installed directly in the evaporator 25.

The water temperature sensor 14 is installed in the hot water flow path 40 near the outlet of the water-cooled condenser 22. The water temperature sensor 14 can also be provided inside the hot water heater 43. The water temperature sensor 14 detects the temperature of the hot water that is exhausted from the hot water heater 43 and led to the heater core 42.

The outside air temperature sensor 15 detects the temperature of outside air before being captured and passing through the outdoor heat exchanger 23.

The controller 10 is a microcomputer configured by a CPU (Central Processing Unit), a ROM (Read Only Memory), a RAM (Random Access Memory), etc. It is also possible for the controller 10 to be configured by a plurality of microcomputers. The controller 10 has the air-conditioning device 1 exhibit various functions by having programs stored in the ROM read by the CPU.

As shown in FIG. 2, signals from the discharge pressure sensor 11, the outdoor heat exchanger outlet temperature sensor 12, the evaporator temperature sensor 13, the water temperature sensor 14, and the outside air temperature sensor 15 are input to the controller 10. It is also possible to have signals input to the controller 10 from other sensors that are not illustrated.

Based on the input signals, the controller 10 is programmed so as to execute control of the refrigeration cycle 2. Specifically, as shown by the dashed line in FIG. 1, the controller 10 sets the output of the compressor 21, and executes the opening and closing control of the first opening-closing valve 29 and the second opening-closing valve 30. Also, by sending an output signal (not illustrated), the controller 10 is programmed to execute control of the hot water cycle 4 and the HVAC unit 5.

Also, the controller 10 has a frost determination unit 18 and an operation control unit 19. The frost determination unit 18 and the operation control unit 19 are virtual units for functions of the controller 10 to perform control of the air-conditioning device 1, and do not indicate physical existence.

The frost determination unit 18, when there is a divergence between the temperature of the refrigerant in the outlet of the outdoor heat exchanger 23 and the outside air temperature, determines that it is not possible to sufficiently perform heat exchange between the refrigerant and the outside air with the outdoor heat exchange 23, and that frost has occurred. In specific terms, the frost determination unit 18 compares the detection temperature of the outside air temperature sensor 15 and the detection temperature of the outdoor heat exchanger outlet temperature sensor 12, and determines that the temperature difference of the two is the same or greater than the frost temperature difference at which it is possible for frost to occur on the outdoor heat exchanger 23. The frost determination unit 18, based on the elapsed time (i.e., an accumulated time) of a state in which the temperature difference between the detection temperature of the outside air temperature sensor 15 and the detection temperature of the outdoor heat exchanger outlet temperature sensor 12 is the frost temperature difference or greater, determines that there is a state in which frost can occur on the outdoor heat exchanger 23.

The present invention is not limited to this, and it is also possible for the frost determination unit 18 to determine that the occurrence of frost on the outdoor heat exchanger 23 has started based on the elapsed time of a state in which the temperature difference between the detection temperature of the outside air temperature sensor 15 and the detection temperature of the outdoor heat exchanger outlet temperature sensor 12 is the same or greater than the frost temperature difference. In this case, the frost suppression operation described later is executed so as not to allow frost on the outdoor heat exchanger 23 progress beyond that.

The operation control unit 19 controls the compressor 21 and the blower 52 so that the air led to the vehicle interior becomes the target blowout temperature set based on the required heating performance, and executes the normal heating operation. When the frost determination unit 18 determines that there is a state in which frost can occur, the operation control unit 19 executes the frost suppression operation of, compared to the normal heating operation, decreasing the target blowout temperature and increasing the air flow amount by the blower 52.

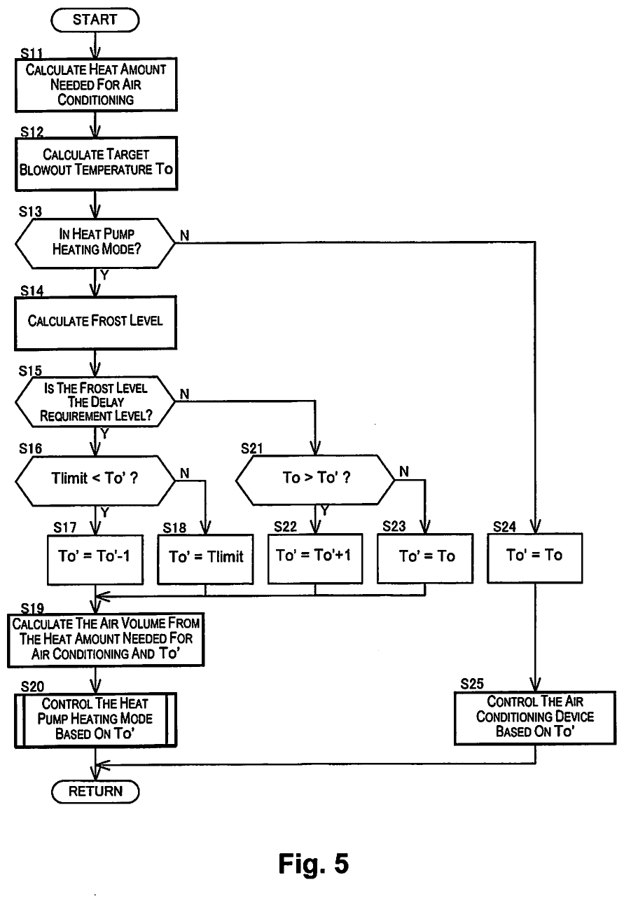

A detailed explanation of the control by the frost determination unit 18 and the operation control unit 19 will be given afterwards while referring to FIG. 5 to FIG. 8.

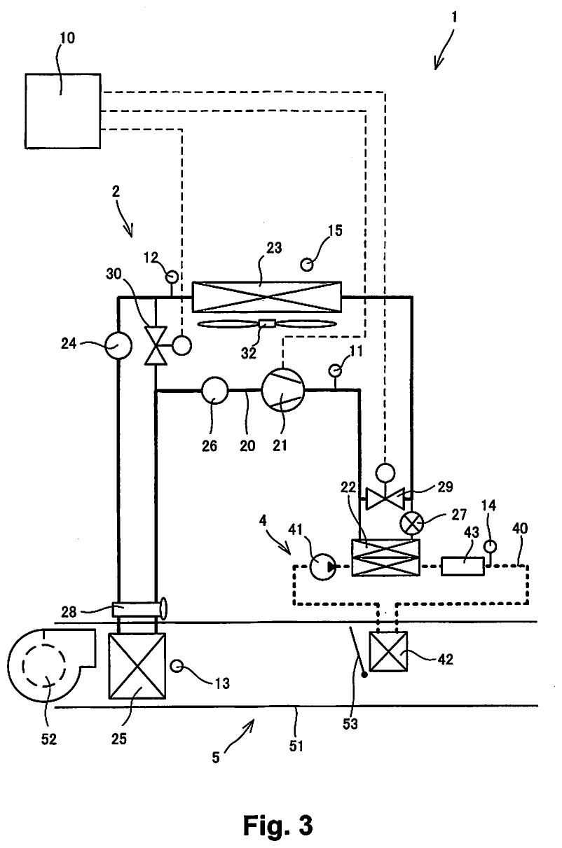

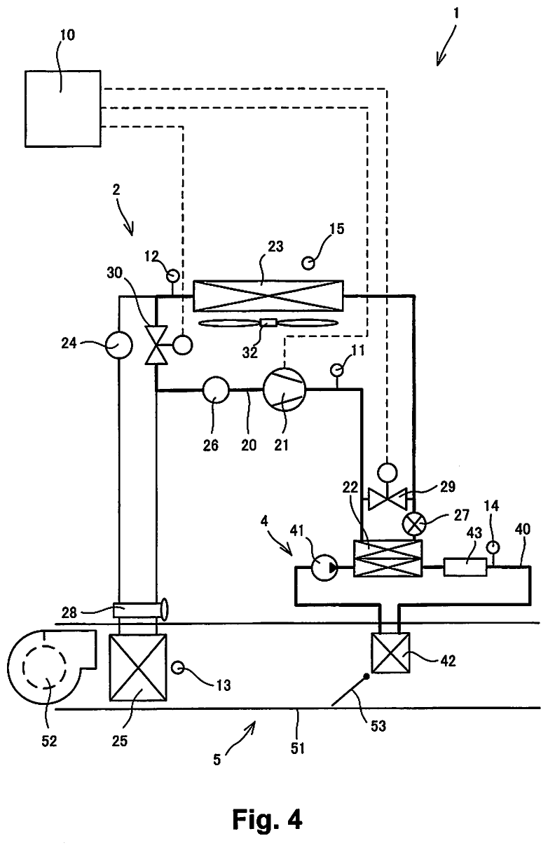

Next, each air conditioning operating mode of the air-conditioning device 1 will be explained while referring to FIG. 3 and FIG. 4.

### Cooling Mode

With the cooling mode shown in FIG. 3, the refrigerant in the refrigerant flow path 20 is circulated as shown by the bold solid line.

The controller 10 puts the second opening-closing valve 30 in a closed state, and puts the first opening-closing valve 29 in an open state. By doing this, the refrigerant compressed to a high temperature and high pressure by the compressor 21 flows as is through the first opening-closing valve 29 to the outdoor heat exchanger 23.

The refrigerant that flowed to the outdoor heat exchanger 23, after being cooled by heat exchange being performed with the outside air introduced to the outdoor heat exchange 23, passes through the liquid tank 24 and undergoes gas-liquid separation. The liquid refrigerant of the refrigerant that underwent gas-liquid separation by the liquid tank 24 flows through the second expansion valve 28 connected to the downstream side of the liquid tank 24.

After that, the liquid refrigerant has pressure reduced and is expanded by the second expansion valve 28 and flows through the evaporator 25, and is vaporized by absorption of the heat of the air used for air conditioning when passing through the evaporator 25. The gaseous refrigerant vaporized by the evaporator 25 again flows to the compressor 21 via the accumulator 26.

The air that is cooled by the refrigerant by the evaporator 25 is used as cooling air that flows to downstream of the HVAC unit 5.

After the water vapor in the air is condensed and removed by the evaporator 25 cooling the air, by reheating with the heater core 42, it is possible to also obtain dehumidified air (dehumidifying mode). In this case, as shown by the bold dashed line in FIG. 3, the hot water inside the hot water flow path 40 is circulated by the water pump 41 while being heated by the hot water heater 43. Also, the air mix door 53 is opened so as to lead the air used for air conditioning to the heater core 42.

### Heating Mode

With the heating mode shown in FIG. 4, a so-called outside air endothermic heat pump operation is executed, and the refrigerant of the refrigerant flow path 20 and the hot water of the hot water flow path 40 are respectively circulated as shown by the bold solid line.

The controller 10 puts the first opening-closing valve 29 in a closed state, and puts the second opening-closing valve 30 in an open state. By doing this, the refrigerant that was compressed and put to a high temperature by the compressor 21 flows to the water-cooled condenser 22.

The refrigerant that flowed to the water-cooled condenser 22, after heat being removing by heating the hot water on the interior of the water-cooled condenser 22 and reaching a low temperature, goes to an even lower temperature by having pressure reduced and being expanded by passing through the first expansion valve 27, and flows to the outdoor heat exchanger 23. The refrigerant that flows to the outdoor heat exchanger 23 is heated and vaporized by performance of heat exchange with the outside air introduced to the outdoor heat exchanger 23. The refrigerant heated by the outdoor heat exchanger 23 passes as is through the second opening-closing valve 30, and undergoes gas-liquid separation by flowing to the accumulator 26. Also, the gaseous refrigerant of the refrigerant that underwent gas-liquid separation by the accumulator 26 again flows to the compressor 21.

The hot water heated by the refrigerant with the water-cooled condenser 22 is circulated and flows to the heater core 42, and heats the air surrounding the heater core 42. The air that is blown by the blower 52 and passes through the heater core 42 to be heated is used as heating air by being flowed to the downstream side of the HVAC unit 5.

When it is not possible for the refrigerant to sufficiently heat the hot water with the water-cooled condenser 22, the hot water can also be heated by operating the hot water heater 43 jointly with the outside air endothermic heat pump operation, or independently.

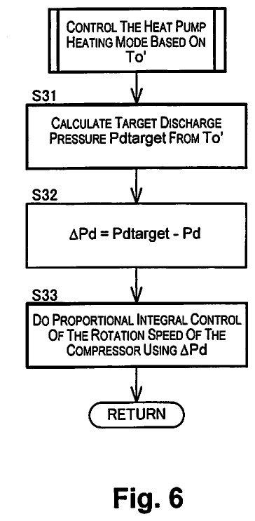

Next, referring to FIG. 5 to FIG. 8, the frost suppression control for suppressing frost on the outdoor heat exchanger 23 during the heating operation is explained. The controller 10 repeatedly executes the routine shown in FIG. 5 and FIG. 6 during operation of the air condition device 1, at fixed time intervals of every 10 milliseconds, for example.

At step S11 in FIG. 5, the controller 10 calculates the heat amount necessary for air conditioning. In specific terms, the vehicle interior temperature detected by the vehicle interior temperature sensor (not illustrated), the outside air temperature detected by the outside air temperature sensor 15, the set temperature set using an operating switch (not illustrated) in the vehicle interior, and the solar radiation amount detected by a solar radiation sensor (not illustrated) are input to the controller 10. The controller 10 calculates the heat amount that needs to be supplied to the vehicle interior from these input values.

At step S12, based on the amount of heat needed for air conditioning calculated at step S11, the controller 10 calculates the target blowout temperature To [° C.] that is the target temperature of the air led to the vehicle interior. At this time, based on the amount of heat needed for air conditioning and the target blowout temperature To, the controller 10 calculates the weight flow rate of the air needed to be led to the vehicle interior. Based on the target blowout temperature To and the weight flow rate of the air, the controller 10 sets the rotation speed of the compressor 21 and the rotation speed of the blower 52.

At step S13, the controller 10 determines whether the air-conditioning device 1 is executing operation using the heat pump heating mode (outside air endothermic heat pump operation). At step S13, when the air condition device is determined to be executing operation using the heat pump heating mode, the process moves to step S14. On the other hand, at step S13, when it is determined that the air-conditioning device 1 is not executing operation using the heat pump heating mode, specifically, that it is executing operation using another mode, the process moves to step S24.

At step S14, based on the detection temperature of the outside air temperature sensor 15 and the detection temperature of the outdoor heat exchanger outlet temperature sensor 12, the controller 10 calculates the frost level of the outdoor heat exchanger 23. The frost level can be set to three levels, for example a non-frost level for which there is no risk of frost occurring on the outdoor heat exchanger 23, a frost delay requirement level for which there is a risk of frost occurring on the outdoor heat exchanger 23 if the operation continues in the state it is currently in, and a frost level for which frost occurrence has started on the outdoor heat exchanger 23.

At step S15, the frost determination unit 18 of the controller 10 determines whether the frost level of the outdoor heat exchanger 23 is at a level requiring delay of the occurrence of frost by suppressing frost (frost delay requirement level). Specifically, the frost determination unit 18 determines that there is a state in which is it possible for frost to occur on the outdoor heat exchanger 23.

In specific terms, the frost determination unit 18 compares the detection temperature of the outside air temperature sensor 15 and the detection temperature of the outdoor heat exchanger outlet temperature sensor 12, and determines that the temperature difference of the two is the same or greater than the frost temperature difference at which frost can occur on the outdoor heat exchanger 23. Based on the elapsed time of the state in which the temperature difference of the detection temperature of the outside air temperature sensor 15 and the detection temperature of the outdoor heat exchanger outlet temperature sensor 12 is the same or greater than the frost temperature difference, the frost determination unit 18 determines that there is a state in which frost can occur on the outdoor heat exchanger 23.

At step S15, when it is determined that the frost level of the outdoor heat exchanger 23 is at a level requiring delaying of the occurrence of frost, it is necessary to switch from the normal heating operation to the frost suppression operation, and the process moves to step S16. On the other hand, at step S15, when it is determined that the frost level of the outdoor heat exchanger 23 is low, and that it is a level at which it is not necessary to delay the occurrence of frost, the normal heating operation is continued, and the process moves to step S21.

In from step S16 to step S18, since it was determined at step S15 that the frost level of the outdoor heat exchanger 23 is at a level of delaying the occurrence of frost, control is executed to switch from the normal heating operation to the frost suppression operation, and to decrease the target blowout temperature from To to Tlimit [° C.].

At step S16, the controller 10 uses the target blowout temperature To′ [° C.] that uses To as the initial value to determine whether To′ is greater than Tlimit which is the lower limit of the target blowout temperature during the heating operation. Here, when there is a sudden change from To to Tlimit, the operation of the refrigeration cycle 2 abruptly changes, so using To′, the target blowout temperature is gradually changed from To to Tlimit.

At step S16, when it is determined that To′ is greater than Tlimit, specifically, that the target blowout temperature To′ has not decreased to the lower limit during the heating operation, the process moves to step S17. On the other hand, at step S16, when it is determined that the target blowout temperature To′ has decreased to the lower limit during the heating operation, the process moves to step S18.

At step S17, the controller 10 decreases To′ from the original To′ by 1 [° C.], and sets to To′−1 [° C.] (To′=To′−1). In this way, the controller 10 gradually changes the target blowout temperature from To to Tlimit (here, this is 1 [° C.] at a time).

At step S18, To′ decreases to the lower limit during the heating operation, so To′ is set to Tlimit (To′=Tlimit).

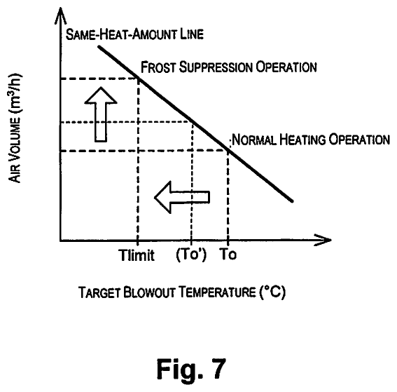

At step S19, the controller 10 calculates the air flow amount by the blower 52 from the heat amount needed for air conditioning calculated at step S11 and the target blowout temperature To′. In specific terms, the air flow amount by the blower 52 is determined based on the same-heat-amount line shown in FIG. 7. In FIG. 7, the horizontal axis is the target blowout temperature [° C.], and the vertical axis is the air flow amount [m³/h].

As shown in FIG. 7, the operation control unit 19 regulates the air flow amount of the blower 52 so that the heat amount of the air led to the vehicle interior is the same as when doing the normal heating operation.

Thus, even if switched from the normal heating operation to the frost suppression operation, the heat amount of the air led to the vehicle interior is the same, so it is possible to keep the equivalent heating sense as in the normal heating operation.

At step S19, based on the same-heat-amount line of the heat amount needed for air conditioning calculated at step S11, the controller 10 gradually decreases from the air flow amount corresponding to To, and finally is set to the air flow amount corresponding to Tlimit.

In this way, the operation control unit 19 decreases the target blowout temperature To′ to the lower limit Tlimit during the heating operation.

By decreasing the target blowout temperature To′ to Tlimit, it is possible to set the rotation speed of the compressor 21 to the minimum. Thus, it is possible to decrease the pressure of the refrigerant compressed by the compressor 21 to a minimum, significantly raise the pressure of the refrigerant led to the outdoor heat exchanger 23, and raise the evaporation temperature. Therefore, it is possible to suppress to the maximum the occurrence of frost on the outdoor heat exchanger 23.

At step S20, the controller 10 executes operation using the heat pump heating mode based on the target blowout temperature To′. The specific control is explained using the flow shown in FIG. 6.

At step S31, the controller 10 calculates a target discharge pressure Pdtarget [Pa] of the compressor 21 corresponding to the target blowout temperature To′.

At step S32, the controller 10 decreases the current discharge pressure Pd [Pa] of the compressor 21 from the Pdtarget calculated at step S31, and calculates a differential pressure iPd [Pa].

At step S33, the controller 10 uses the iPd calculated at step S32 and does proportional integral control of the rotation speed of the compressor 21.

As described above, by the control of step S31 to step S33, the rotation speed of the compressor 21 is regulated to a rotation speed corresponding to the target blowout temperature To′. Thus, when the frost determination unit 18 determines that there is a state in which frost can occur, the operation control unit 19 executes the frost suppression operation that, compared to the normal heating operation, decreases the target blowout temperature To′ and increases the air flow amount by the blower 52.

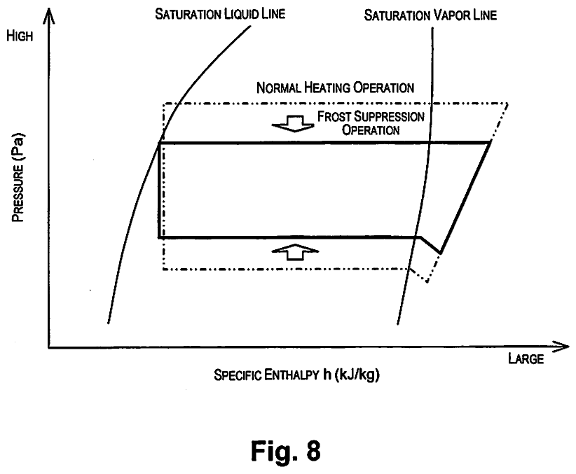

In this way, when in a state in which frost can occur on the outdoor heat exchanger 23, the operation control unit 19 executes the frost suppression operation. With the frost suppression operation, the target blowout temperature To′ of the air led to the vehicle interior is decreased, and the air flow amount by the blower 52 is increased. By doing this, as shown in FIG. 8, the pressure of the refrigerant compressed by the compressor 21 drops, the pressure of the refrigerant led to the outdoor heat exchanger 23 rises, and the evaporation temperature rises, so the occurrence of frost on the outdoor heat exchanger 23 is suppressed. On the other hand, the air flow amount by the blower 52 increases by the amount that the target blowout temperature To′ decreases, so the heat amount of the air led to the vehicle interior does not decrease. Therefore, it is possible to suppress frost on the outdoor heat exchanger 23 without decreasing the heating performance.

Returning to the flow in FIG. 5, with step S21 through step S23, since there was determined to be a level for which delaying of the occurrence is not necessary (non-frost level) at step S15, there is a switch from the frost suppression operation to the normal heating operation, and control is executed to return the target blowout temperature from Tlimit to To.

At step S21, a determination is made of whether the target blowout temperature To′ is smaller than the target blowout temperature To calculated at step S12. When determined at step S21 that To is greater than To′ (To>To′), the process moves to step S22. On the other hand, when it is determined at step S21 the relationship To>To′ is not satisfied, in other words, that To′ rises to To, the process moves to step S23.

At step S22, the controller 10 raises To′ from the original To′ by 1 [° C.], and sets to To′+1 [° C.] (To′=To′+1). In this way, the controller 10 gradually changes the target blowout temperature from Tlimit to To (here, 1 [° C.] at a time).

At step S23, To′ had risen to the target blowout temperature To calculated at step S12, so the controller 10 sets To′ to To (To′=To).

Also, from step S22 and step S23, the process moves to step S19, and the control described above is executed.

In this way, when the operation control unit 19 is executing the frost suppression operation, and the frost determination unit 18 determines that there is a state for which frost will not occur, the normal heating operation is executed.

Thus, the frost suppression operation is executed only when it is necessary to suppress and delay frost, so it is possible to maintain the heating sense in the vehicle interior.

At step S13, when it is determined that the air-conditioning device 1 will not execute operation using the heat pump hating mode, specifically, will execute the operation using another mode, the process moves to step S24.

At step S24, since there is no risk of frost occurring on the outdoor heat exchanger 23, the controller 10 sets To′=To.

At step S25, the controller 10 controls the air condition device 1 according to each operating mode based on To′.

According to the embodiments described above, the effects shown hereafter are exhibited.

The air-conditioning device 1 comprises: a compressor 21 that compresses a refrigerant; the heater (water-cooled condenser 22, hot water cycle 4) that heats the air led to the vehicle interior using heat when the refrigerant compressed by the compressor 21 condenses; the first expansion valve 27 that expands the refrigerant condensed by the heater; the outdoor heat exchanger 23 that vaporizes the refrigerant expanded using the first expansion valve 27 by heat exchange with outside air; the blower 52 that blows air led to the vehicle interior so as to pass through the heater core 42; the outside air temperature sensor 15 that detects the temperature of the outside air before passing through the outdoor heat exchanger 23; the outdoor heat exchanger outlet temperature sensor 12 that detects the temperature of the refrigerant that passed through the outdoor heat exchanger 23; the frost determination unit 18 that determines there is a state in which frost can occur on the outdoor heat exchanger 23, based on the elapsed time of a state in which the difference between the detection temperature of the outside air temperature sensor 15 and the detection temperature of the outdoor heat exchanger outlet temperature sensor 12 is the same or greater than the frost temperature difference at which frost can occur on the outdoor heat exchanger 23; and the operation control unit 19 that controls the compressor 21 and the blower 52 to execute the normal heating operation so that the air led to the vehicle interior becomes a target blowout temperature set based on the required heating performance, and executes a normal heating operation. When the frost determination unit 18 determines that there is a state in which frost can occur, the operation control unit 19 executes the frost suppression operation of, compared to the normal heating operation, decreasing the target blowout temperature To′ and increasing the air flow amount by the blower 52.

According to this configuration, when there is a state in which frost can occur on the outdoor heat exchanger 23, the operation control unit 19 executes the frost suppression operation. With the frost suppression operation, the air led to the vehicle interior is decreased to the target blowout temperature To′, and the air flow amount by the blower 52 is increased. By doing this, the pressure of the refrigerant compressed by the compressor 21 drops, the pressure of the refrigerant led to the outdoor heat exchanger 23 rises, and the evaporation temperature rises, so the occurrence of frost on the outdoor heat exchanger 23 is suppressed. On the other hand, the air flow amount by the blower 52 increases by the amount that the target blowout temperature To′ decreased, so there is no decrease in the heat amount of the air led to the vehicle interior. Therefore, it is possible to suppress frost to the outdoor heat exchanger 23 without decreasing the heating performance.

Also, the operation control unit 19 regulates the air flow amount of the blower 52 so that the heat amount of the air led to the vehicle interior is the same as when doing the normal heating operation.

According to this configuration, even if switched from the normal heating operation to the frost suppression operation, the heat amount of the air led to the vehicle interior is the same, so it is possible to maintain the equivalent heating sense as with the normal heating operation.

Also, the operation control unit 19 decreases the target blowout temperature To′ to the lower limit Tlimit during the heating operation.

According to this configuration, by decreasing the target blowout temperature To′ to Tlimit, it is possible to set the rotation speed of the compressor 21 to the minimum. Thus, it is possible to decrease the pressure of the refrigerant compressed by the compressor 21, significantly raise the pressure of the refrigerant led to the outdoor heat exchanger 23, and raise the evaporation temperature. Therefore, it is possible to do maximum suppression of the occurrence of frost on the outdoor heat exchanger 23.

Also, when the frost suppression operation is being executed, when the frost determination unit 18 determines that there is a state in which frost will not occur, the operation control unit 19 executes the normal heating operation.

According to this configuration, the frost suppression operation is executed only when it is necessary to suppress and delay frost, so it is possible to maintain the heating sense of the vehicle interior.

Above, an embodiment of the invention was described, but the abovementioned embodiment is nothing more than showing a portion of the application examples of the present invention, and this is not intended to limit the claims of the present invention to the specific configuration of the abovementioned embodiment.

1. An air-conditioning device configured to execute a heating operation, the air-conditioning device comprising:
a compression machine configured to compress a refrigerant;
a heater configured to heat air led to a vehicle interior using heat when the refrigerant compressed by the compression machine condenses;
an expansion valve configured to expand the refrigerant condensed by the heater;
an outdoor heat exchanger configured to vaporize the refrigerant expanded using the expansion valve by heat exchange with outside air;
an air blower configured to blow air led to the vehicle interior so as to pass through the heater;
an outside air temperature detector configured to detect a temperature of outside air before passing through the outdoor heat exchanger;
a refrigerant temperature detector configured to detect a temperature of the refrigerant that passed through the outdoor heat exchanger;
a frost determination unit configured to determine an occurrence of a frost risk state of the outdoor heat exchanger, based on an accumulated time of a state in which a difference between the temperature detected by the outside air temperature detector and the temperature detected by the refrigerant temperature detector is the same or greater than a frost temperature difference at which frost can occur on the outdoor heat exchanger; and
an operation control unit configured to control the compression machine and the air blower so that the air led to the vehicle interior becomes a target blowout temperature set based on a required heating performance, and to execute a normal heating operation, wherein
the operation control unit is configured to, when the frost determination unit has determined the occurrence of the frost risk state, execute a frost suppression operation of, compared to the normal heating operation, decreasing the target blowout temperature and increasing an air flow amount using the air blower.

2. The air-conditioning device of claim 1, wherein
the operation control unit is configured to regulate the air flow amount of the air blower during the frost suppression operation so that a heat amount of the air led to the vehicle interior is the same as during the normal heating operation.

3. The air-conditioning device of claim 2, wherein
the operation control unit is configured to decrease the target blowout temperature to a lower limit for the heating operation, during the frost suppression operation.

4. The air-conditioning device according to claim 2, wherein
when the operation control unit is executing the frost suppression operation, when the frost determination unit determines there is a state in which frost will not occur, the operation control unit is configured to execute the normal heating operation.

5. The air-conditioning device according to claim 3, wherein
when the operation control unit is executing the frost suppression operation, when the frost determination unit determines there is a state in which frost will not occur, the operation control unit is configured to execute the normal heating operation.
